(19) United States
(12) Patent Application Publication
(10) Pub. No.: US 2019/0322407 A1
(43) Pub. Date: Oct. 24, 2019

(54) VARIABLE DEPTH PACKAGING

(71) Applicant: PAC WORLDWIDE CORPORATION, Redmond, WA (US)

(72) Inventor: Murray FULLERTON, Papakura (NZ)

(21) Appl. No.: 16/462,499

(22) PCT Filed: Nov. 16, 2017
(86) PCT No.: PCT/US2017/062036

§ 371 Date: May 20, 2019

Related U.S. Application Data
(60) Provisional application No. 62/425,015, filed on Nov. 21, 2016.

(51) Int. Cl. B65D 5/355; B65D 5/20; B65D 5/42; B31B 50/14; B31B 50/26; B31B 50/62

(52) U.S. Cl. CPC B65D 5/0005; B65D 5/2076; B65D 5/4266; B31B 2120/70; B31B 50/26; B31B 50/624; B31B 50/142

(57) ABSTRACT

A packaging system includes a main body and two side flaps coupled to the main body. The main body and the side flaps can comprise corrugated cardboard. The corrugations of the main body can be perpendicular to the corrugations of the two side flaps. The packaging system can be folded up to package a good in the packaging system, with all folds of the main body and the side flaps made parallel to the corrugations of the respective components.

### BACKGROUND

### Technical Field

The present disclosure relates generally to packaging materials and packaging systems, and more particularly to corrugated cardboard packaging systems that can be folded to have a variety of different depths.

### Description of the Related Art

Corrugated cardboard boxes are widely available in a variety of different sizes. Thus, to package a wide variety of goods having a wide variety of shapes and sizes in corrugated cardboard boxes for shipping, one could purchase a variety of different corrugated cardboard boxes, select one of the purchased boxes for each good to be shipped based on the shapes and sizes of the good to be shipped and of the purchased corrugated cardboard boxes, and then package and ship the good. Such a process would create inefficiencies. For example, a wide variety of boxes would need to be purchased, stored, and tracked. As another example, packaging processes would have to be developed for each of the different boxes. Thus, variable depth packaging systems can provide benefits over standard cardboard boxes.

### BRIEF SUMMARY

A packaging system may be summarized as comprising: a main body including a first sheet of corrugated cardboard having first corrugations oriented in a first corrugation direction, the main body having a first end, a second end opposite the first end across a length of the main body, a first side, a second side opposite the first side across a width of the main body, a first major surface, and a second major surface opposite the first major surface across a thickness of the main body; a first side flap including a second sheet of corrugated cardboard having second corrugations oriented in a second corrugation direction, the first side flap coupled to the first major surface of the main body adjacent to the first side of the main body, the first side flap configured to lie flat against the first major surface of the main body; a second side flap including a third sheet of corrugated cardboard having third corrugations oriented in a third corrugation direction, the second side flap coupled to the first major surface of the main body adjacent to the second side of the main body, the second side flap configured to lie flat against the first major surface of the main body; wherein when the first side flap lies flat against the first major surface of the main body, the first corrugation direction is perpendicular to the second corrugation direction; and wherein when the second side flap lies flat against the first major surface of the main body, the first corrugation direction is perpendicular to the third corrugation direction.

The first side flap may include a first edge immediately adjacent to the first side of the main body and the second side flap may include a second edge immediately adjacent to the second side of the main body. The first side flap may have a first overall length, the second side flap may have a second overall length, and a sum of the first and second overall lengths may be greater than the width of the main body. The first side flap may include a plurality of fold lines. The main body may include a plurality of fold lines. The packaging system may further comprise a pressure sensitive adhesive positioned on the first major surface of the main body adjacent to the second end of the main body, and a release liner positioned on the pressure sensitive adhesive. The packaging system may further comprise a tear strip positioned on the first major surface of the main body adjacent to the pressure sensitive adhesive and to the release liner.

The packaging system may further comprise a second pressure sensitive adhesive positioned on the first major surface of the main body adjacent to the tear strip, and a second release liner positioned on the second pressure sensitive adhesive. The first side flap, the second side flap, the first end of the main body, and the second end of the main body may be configured to be folded to form and completely enclose an internal void space. The void space may have a length of 10½ inches, a width of 6⅝ inches, and a thickness of 15/16 inches. The void space may have a length of 10½ inches, a width of 6⅝ inches, and a thickness of 2⅜ inches. The first sheet of corrugated cardboard may have a first grade, the second sheet of corrugated cardboard may have a second grade that is different than the first grade, and the third sheet of corrugated cardboard may have a third grade that is different than the first grade.

A method of manufacturing a packaging system may be summarized as comprising: forming a main body of the packaging system from a first sheet of corrugated cardboard, the main body including first corrugations oriented in a first corrugation direction, a first end, a second end opposite the first end across a length of the main body, a first side, a second side opposite the first side across a width of the main body, a first major surface, and a second major surface opposite the first major surface across a thickness of the main body; forming a first side flap of the packaging system and a second side flap of the packaging system from a second sheet of corrugated cardboard, the first side flap including second corrugations oriented in a second corrugation direction, the second side flap including third corrugations oriented in a third corrugation direction; coupling the first side flap to the first major surface of the main body adjacent to the first side of the main body so that the first side flap is configured to lie flat against the first major surface of the main body and when the first side flap lies flat against the first major surface of the main body, the first corrugation direction is perpendicular to the second corrugation direction; and coupling the second side flap to the first major surface of the main body adjacent to the second side of the main body so that the second side flap is configured to lie flat against the first major surface of the main body and when the second side flap lies flat against the first major surface of the main body, the first corrugation direction is perpendicular to the third corrugation direction.

Forming a first side flap of the packaging system and a second side flap of the packaging system from a second sheet of corrugated cardboard may include stamping the first side flap and the second side flap as an integral unit and then separating the first side flap from the second side flap.

A method of using a packaging system comprising: a main body including a first sheet of corrugated cardboard having first corrugations oriented in a first corrugation direction, the main body having a first end, a second end opposite the first end across a length of the main body, a first side, a second side opposite the first side across a width of the main body, a first major surface, and a second major surface opposite the first major surface across a thickness of the main body; a first side flap including a second sheet of corrugated cardboard having second corrugations oriented in a second corrugation direction, the first side flap coupled to the first major surface of the main body adjacent to the first side of the main body, the first side flap configured to lie flat against the first major surface of the main body; a second side flap including a third sheet of corrugated cardboard having third corrugations oriented in a third corrugation direction, the second side flap coupled to the first major surface of the main body adjacent to the second side of the main body, the second side flap configured to lie flat against the first major surface of the main body; wherein when the first side flap lies flat against the first major surface of the main body, the first corrugation direction is perpendicular to the second corrugation direction; and wherein when the second side flap lies flat against the first major surface of the main body, the first corrugation direction is perpendicular to the third corrugation direction, the method may be summarized as comprising: folding the first side flap along a first fold line parallel to the second corrugation direction so the first side flap extends away from the main body; folding the second side flap along a second fold line parallel to the third corrugation direction so the second side flap extends away from the main body; positioning an item to be packaged on the first major surface of the main body between the first and second side flaps; folding the first side flap along a third fold line parallel to the second corrugation direction so the first side flap extends over the top of the item; folding the second side flap along a fourth fold line parallel to the third corrugation direction so the second side flap extends over the top of the item; folding the main body along a fifth fold line parallel to the first corrugation direction so the first end of the main body is raised upward from the rest of the main body; folding the main body along a sixth fold line parallel to the first corrugation direction so the first end of the main body extends over the top of the item; folding the main body along a seventh fold line parallel to the first corrugation direction so the second end of the main body is raised upward from the rest of the main body; and folding the main body along an eighth fold line parallel to the first corrugation direction so the second end of the main body extends over the top of the item.

The method may further comprise: removing a release liner from a pressure sensitive adhesive positioned on the first major surface of the main body adjacent to the second end of the main body; and pressing the pressure sensitive adhesive into the second major surface of the main body to secure the first major surface of the main body to the second major surface of the main body.

### BRIEF DESCRIPTION OF THE SEVERAL VIEWS OF THE DRAWINGS

FIG. 1 illustrates a variable depth corrugated cardboard packaging system, according to at least one illustrated embodiment.

FIG. 2 is an exploded view of the packaging system of FIG. 1.

FIG. 3 illustrates a main body of the packaging system of FIG. 1.

FIG. 4 illustrates a portion of the main body of FIG. 3.

FIG. 5 illustrates side flaps of the packaging system of FIG. 1.

FIG. 6 illustrates the packaging system of FIG. 1 in a first, narrow folded configuration.

FIG. 7 illustrates a cross-sectional view of the packaging system of FIG. 6.

FIG. 8 illustrates another cross-sectional view of the packaging system of FIG. 6.

FIG. 9 illustrates the packaging system of FIG. 1 in a second, wide folded configuration.

FIG. 10 illustrates a cross-sectional view of the packaging system of FIG. 9.

FIG. 11 illustrates another cross-sectional view of the packaging system of FIG. 9.

FIG. 12 illustrates another variable depth corrugated cardboard packaging system, according to at least one illustrated embodiment.

FIG. 13 is an exploded view of the packaging system of FIG. 12.

FIG. 14 illustrates a main body of the packaging system of FIG. 12.

FIG. 15 illustrates side flaps of the packaging system of FIG. 12.

FIG. 16 illustrates the packaging system of FIG. 12 in a first, narrow folded configuration.

FIG. 17 illustrates a cross-sectional view of the packaging system of FIG. 16.

FIG. 18 illustrates another cross-sectional view of the packaging system of FIG. 16.

FIG. 19 illustrates the packaging system of FIG. 12 in a second, wide folded configuration.

FIG. 20 illustrates a cross-sectional view of the packaging system of FIG. 19.

FIG. 21 illustrates another cross-sectional view of the packaging system of FIG. 19.

FIG. 22 illustrates a sheet of corrugated cardboard, according to at least one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with the technology have not been shown or described in detail to avoid unnecessarily obscuring descriptions of the embodiments.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Also, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The use of ordinals such as first, second and third does not necessarily imply a ranked sense of order, but rather may only distinguish between multiple instances of an act or structure.

Terms of geometric alignment are used herein. Any components of the embodiments that are illustrated, described, or claimed herein as being aligned, arranged in the same direction, parallel, or having other similar geometric relationships with respect to one another have such relationships in the illustrated, described, or claimed embodiments. In alternative embodiments, however, such components can have any of the other similar geometric properties described herein indicating alignment with respect to one another. Any components of the embodiments that are illustrated, described, or claimed herein as being not aligned, arranged in different directions, not parallel, perpendicular, transverse, or having other similar geometric relationships with respect to one another, have such relationships in the illustrated, described, or claimed embodiments. In alternative embodiments, however, such components can have any of the other similar geometric properties described herein indicating non-alignment with respect to one another.

Various examples of suitable dimensions of components are provided herein. In the illustrated, described, and claimed embodiments, such dimensions are accurate to within standard manufacturing tolerances unless stated otherwise. Such dimensions are examples, however, and can be modified to produce variations of the components and systems described herein. For example, in various alternative embodiments, such dimensions can be approximations wherein the actual dimensions can vary by up to 1, 2, 5, 10, 15 or more percent from the stated, approximate dimensions.

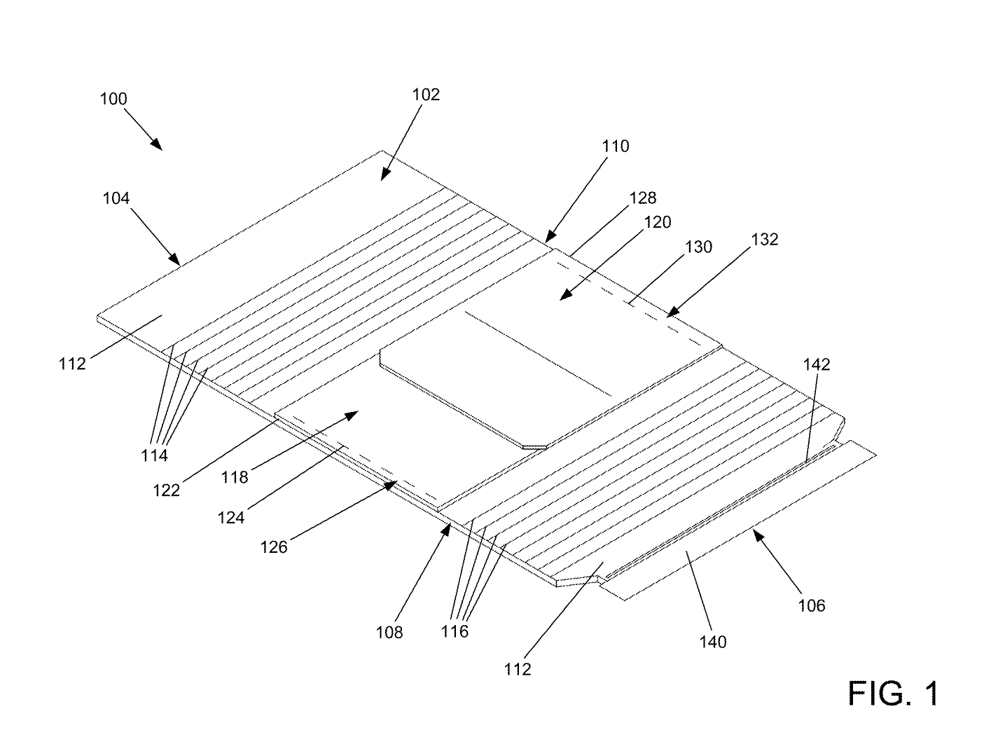

FIG. 1 illustrates a variable depth corrugated cardboard packaging system 100. The packaging system 100 includes a main body 102 having a generally rectangular overall shape. The main body 102 has a first end 104, a second end 106 opposite the first end 104 across a length of the main body 102, a first side 108, and a second side 110 opposite the first side 108 across a width of the main body 102. The length of the main body 102 is transverse or perpendicular to the width of the main body 102, and the length of the main body 102 is greater than the width of the main body 102.

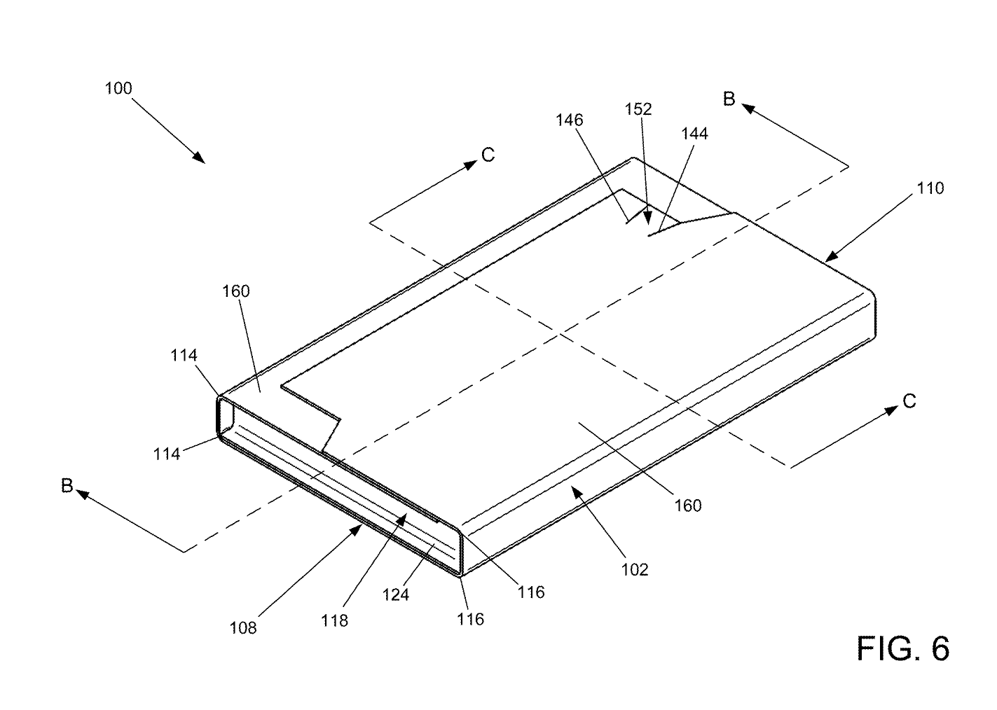

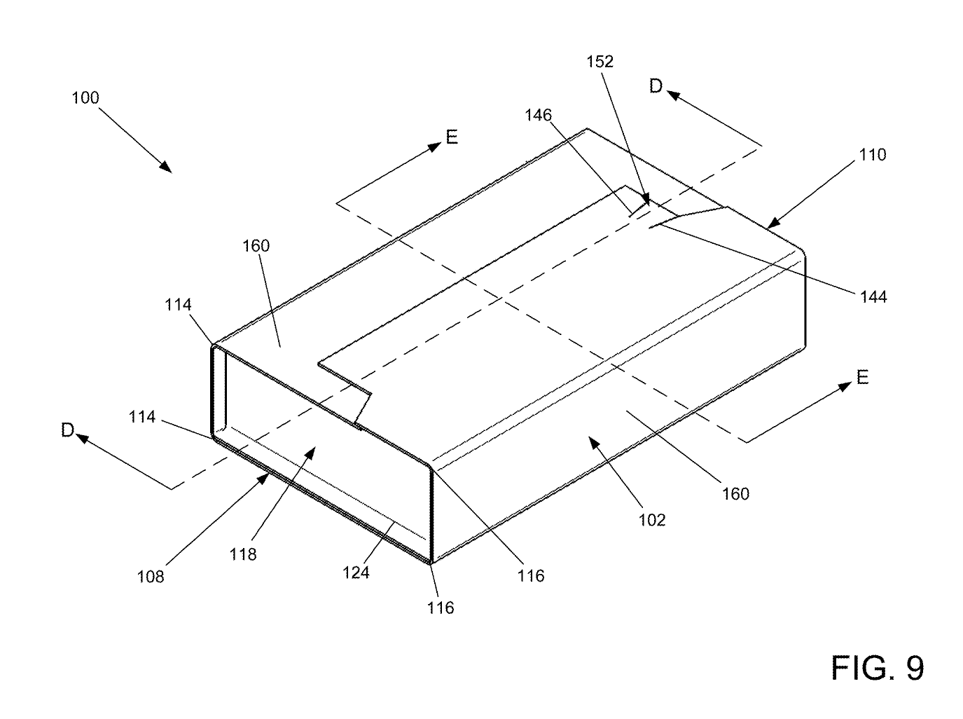

The main body 102 also has a first major surface 112 that spans between the first and second ends 104, 106 of the main body 102 and the first and second sides 108, 110 of the main body 102, and a second major surface 160 (FIGS. 6 and 9), opposite to the first major surface 112 across a thickness of the main body 102, that spans between the first and second ends 104, 106 of the main body 102 and the first and second sides 108, 110 of the main body 102. The thickness of the main body 102 is transverse or perpendicular to the length of the main body 102 and the width of the main body 102, and the length of the main body 102 and the width of the main body 102 are greater than the thickness of the main body 102.

In some embodiments, the main body 102 comprises a sheet of corrugated cardboard having a thickness of about 1/16 of an inch and flutes that extend from the first side 108 to the second side 110, that is, along or parallel to the width of the main body 102. The main body 102 also includes a first plurality of fold lines 114 and a second plurality of fold lines 116, each of which extend from the first side 108 to the second side 110, that is, along or parallel to the width of the main body 102 and therefore also parallel to the direction of the corrugations or flutes of the corrugated cardboard. Each of the fold lines 114 and 116 can comprise a scoreline cut into the first major surface 112 and/or the second major surface 160 of the main body 102. Each of the fold lines 114 and 116 can also, or in the alternative, comprise a pre-crushed fold line and/or a machine-crushed fold line. Each of the fold lines 114 and 116 can also, or in the alternative, comprise a perforated cut through the full thickness of the main body 102. The fold lines 114 and 116 can make it simpler and more efficient for a human or a machine to fold up the packaging system 100 to package a good therein.

FIG. 1 also illustrates that the packaging system 100 includes a first side flap 118 and a second side flap 120, each of which are coupled, affixed, or connected to the main body 102. The first side flap 118 has a first edge 122, a primary fold line 124 adjacent to, parallel to, and spaced apart from the first edge 122, and a first end portion 126 extending between the first edge 122 and the adjacent primary fold line 124. The first side flap 118 is coupled (e.g., adhered with a pressure sensitive adhesive or any hot melt adhesive, or glued using hot or cold glue, with hot and cold glue being particularly advantageous) to the main body 102 along the length of its first end portion 126, so that its first edge 122 is immediately adjacent and parallel to the first side 108 of the main body 102, and so that the first side flap 118 can be folded along its primary fold line 124 to stand upward on and extend away from the first major surface 112 of the main body 102.

Similarly, the second side flap 120 has a first edge 128, a primary fold line 130 adjacent to, parallel to, and spaced apart from the first edge 128, and a first end portion 132 extending between the first edge 128 and the adjacent primary fold line 130. The second side flap 120 is coupled (e.g., adhered with a pressure sensitive adhesive or any hot melt adhesive, or glued using hot or cold glue, with hot and cold glue being particularly advantageous) to the main body 102 along the length of its first end portion 132, so that its first edge 128 is immediately adjacent and parallel to the second side 110 of the main body 102, and so that the second side flap 120 can be folded along its primary fold line 130 to stand upward on and extend away from the first major surface 112 of the main body 102.

In some embodiments, the first and second side flaps 118, 120 each comprise a sheet of corrugated cardboard having a thickness of about 1/16 of an inch and corrugations or flutes that extend across the side flap 118 or 120 in a direction parallel to the respective first edge 122 or 128. Thus, the corrugations or flutes of the first and second side flaps 118, 120 can be perpendicular to the corrugations or flutes of the main body 102. As also illustrated in FIG. 1, the first side flap 118 can have an overall length perpendicular to its first edge 122, the second side flap 120 can have an overall length perpendicular to its first edge 128, and a sum of the overall lengths of the first and second side flaps 118, 120 can be greater than the width of the main body 102. In alternative implementations, the sum of the overall lengths of the first and second side flaps 118, 120 can be less than, or can be equal to, the width of the main body 102.

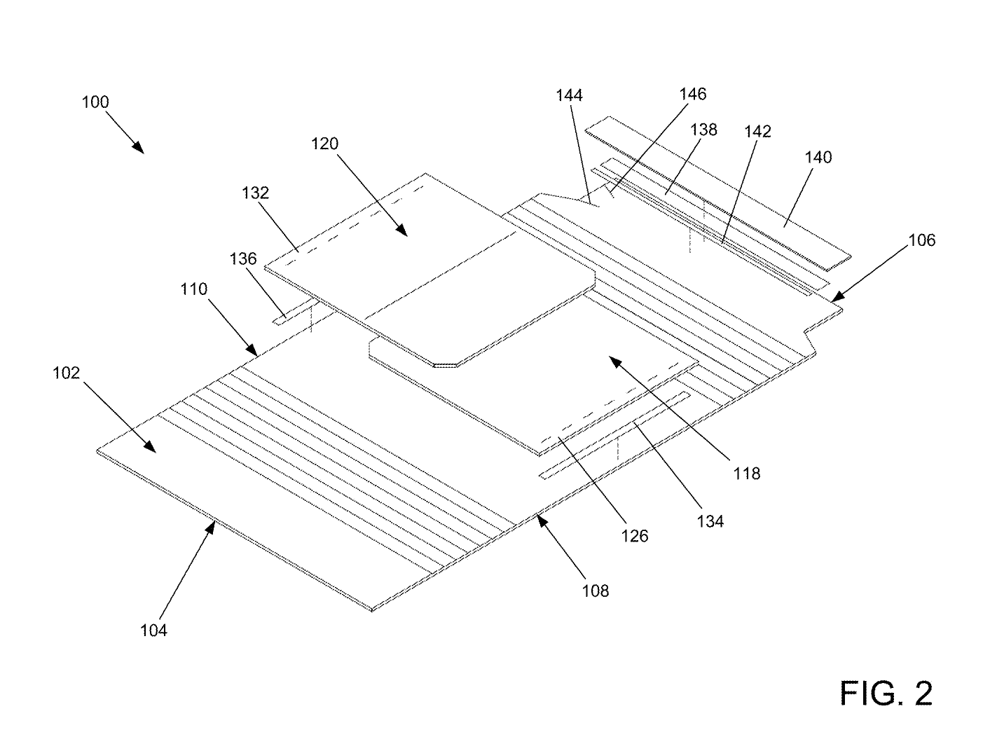

FIG. 2 illustrates an exploded view of the packaging system 100 that shows how the various components of the packaging system 100 are coupled to one another. For example, FIG. 2 illustrates that the packaging system 100 includes a first layer or strip of adhesive or glue (e.g., a pressure sensitive adhesive or any hot melt adhesive, or a hot or cold glue, with a hot or cold glue being particularly advantageous) 134, and a second layer or strip of adhesive or glue (e.g., a pressure sensitive adhesive or any hot melt adhesive, or a hot or cold glue, with a hot or cold glue being particularly advantageous) 136.

The first layer of adhesive 134 can be positioned on the first major surface 112 of the main body 102 adjacent to, parallel to, and along at least a portion of the first side 108 of the main body 102, and the first end portion 126 of the first side flap 118 can be positioned on top of the first layer of adhesive 134 so that the first side flap 118 is adhered to the main body 102. Similarly, the second layer of adhesive 136 can be positioned on the first major surface 112 of the main body 102 adjacent to, parallel to, and along at least a portion of the second side 110 of the main body 102, and the first end portion 132 of the second side flap 120 can be positioned on top of the second layer of adhesive 136 so that the second side flap 120 is adhered to the main body 102.

FIG. 2 also illustrates that the packaging system 100 includes a third layer or strip of adhesive or glue (e.g., a pressure sensitive adhesive or any hot melt adhesive, or a hot or cold glue, with a pressure sensitive adhesive, a hot glue, or any holt melt adhesive being particularly advantageous) 138, which can be positioned on the first major surface 112 of the main body 102 adjacent to, parallel to, and along at least a portion of the second end 106 of the main body 102. The packaging system 100 also includes a release liner 140 that can be made of a silicone-coated paper or polyolefin and that is positioned on top of the third layer of adhesive 138 so that it is adhered to the main body 102. The release liner 140 can be made from any one of various suitable materials known in the art, so that it is adhered to the main body 102 by the third layer of adhesive 138, and so that it can be easily pulled off of the main body 102 and the third layer of adhesive 138, by a human or by a machine, to reveal an upper surface of the third layer of adhesive 138. Forming the strip of adhesive 138 and any other adhesives described herein using a pressure sensitive adhesive can be particularly advantageous. For example, many commercially available packaging systems use double-sided tape, which can cost approximately 4.0 cents per adhesive unit, rather than pressure-sensitive adhesive with a release liner, which can cost approximately 0.3 cents per adhesive unit.

FIG. 2 also illustrates that the main body 102 includes two angled slits or cuts 144 and 146 extending into the main body 102 from its second side 110 toward its first side 108 near to its second end 106. The packaging system 100 also includes a tear strip 142, which can be positioned on the first major surface 112 of the main body 102 adjacent to and parallel to the release liner 140, and which can be coupled, adhered, or glued thereto so that it extends from a second end of the tear strip 142 positioned adjacent the second side 110 of the main body 102 and between the two cuts 144 and 146, to a first end of the tear strip 142 positioned adjacent to the first side 108 of the main body 102.

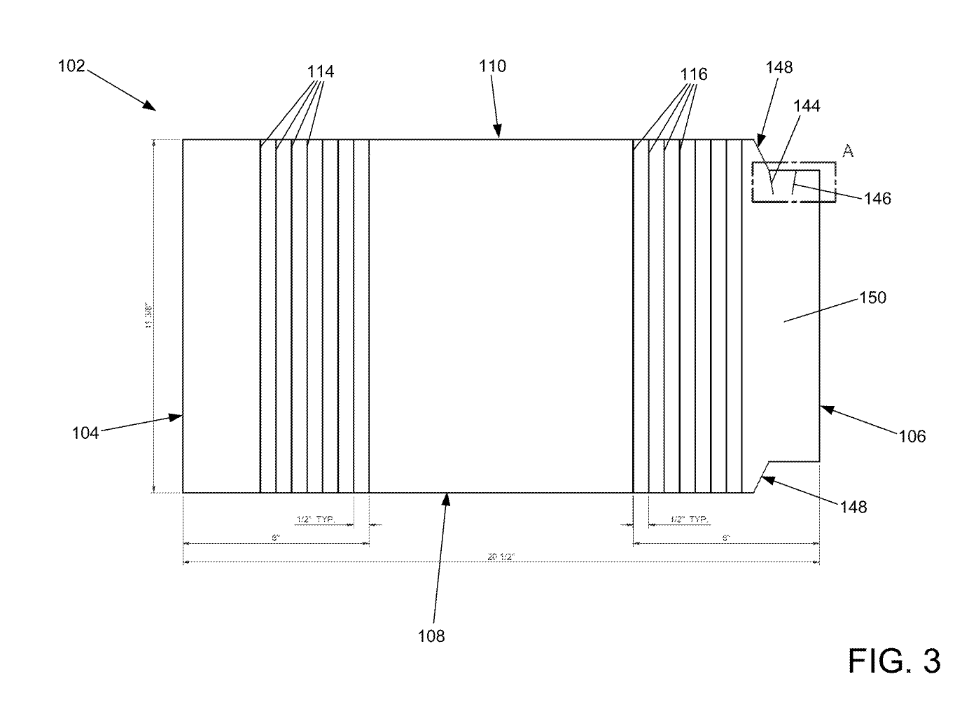

FIG. 3 illustrates the main body 102 by itself, including various dimensions of the main body 102. As a first example, FIG. 3 illustrates that the main body 102 can have an overall length extending from the first end 104 to the second end 106 of 20½ inches, and an overall width extending from the first side 108 to the second side 110 of 11⅜ inches. The first plurality of fold lines 114 can include eight distinct fold lines 114 that extend parallel to one another along the width of the main body 102, and a furthest-inboard one of the fold lines 114, which is located the furthest of the fold lines 114 from the first end 104 of the main body 102, is located 6 inches from the first end 104 of the main body 102. The rest of the first plurality of fold lines 114 can be spaced ½ inch apart from one another, such that the one of the fold lines 114 located closest to the first end 104 is spaced apart from the first end 104 by 2½ inches.

Similarly, the second plurality of fold lines 116 can include eight distinct fold lines 116 that extend parallel to one another along the width of the main body 102, and a furthest-inboard one of the fold lines 116, which is located the furthest of the fold lines 116 from the second end 106 of the main body 102, is located 6 inches from the second end 106 of the main body 102. The rest of the second plurality of fold lines 116 can be spaced ½ inch apart from one another, such that the one of the fold lines 116 located closest to the second end 106 is spaced apart from the second end 106 by 2½ inches. FIG. 3 also illustrates that the width of the main body 102 tapers at a taper portion 148, located near the second end 106, from its overall width to an end portion 150, which includes the second end 106 and has a smaller width than the overall width of the main body 102. The main body 102 can be stamped or die cut to have the configuration, dimensions, and features described herein.

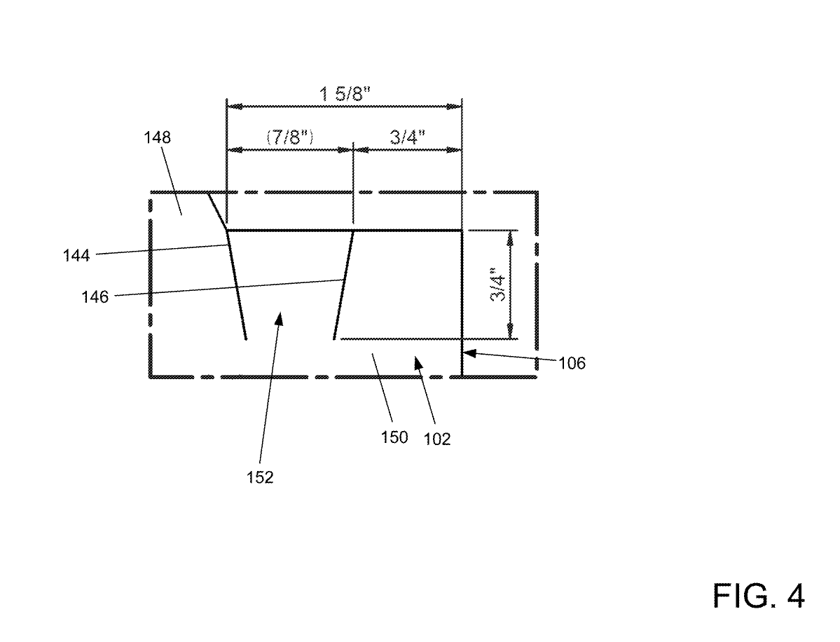

FIG. 4 illustrates a larger view of a part of the end portion 150 of the main body 102 indicated by reference character A in FIG. 3. As shown in FIG. 4, a first cut 144 can originate at the location where the taper portion 148 meets the end portion 150, which can be 1⅝ inches from the second end 106 of the main body 102. The first cut 144 can extend from its origination location into the end portion 150 and toward the second end 106 of the main body 102, to a termination location ¾ of an inch into the end portion 150 along a dimension parallel to the second end 106. A second cut 146 can originate at a location ⅞ of an inch toward the second end 106 from the origination location for the first cut 144 and ¾ of an inch from the second end 106. The second cut 146 can extend from its origination location into the end portion 150 and away from the second end 106 of the main body 102, to a termination location ¾ of an inch into the end portion 150 along a dimension parallel to the second end 106.

The first and second cuts can be die cut all the way through the main body 102, so that a portion of the main body located between the two cuts 144, 146 can form an easy-opening tear tab 152 that decreases in width as it extends into the end portion 150. As shown in FIG. 1, the second end of the tear strip 142 is positioned adjacent the second side 110 of the main body 102 and between the two cuts 144 and 146. Thus, when the packaging system 100 is used, a user can pull the tab 152 formed between the cuts 144 and 146 away from the rest of the main body 102 to begin tearing the end portion 150 apart, and can pull the tab 152 further away from the rest of the main body 102 to pull the tear strip 142 to continue tearing across the width of the end portion 150, as discussed further below.

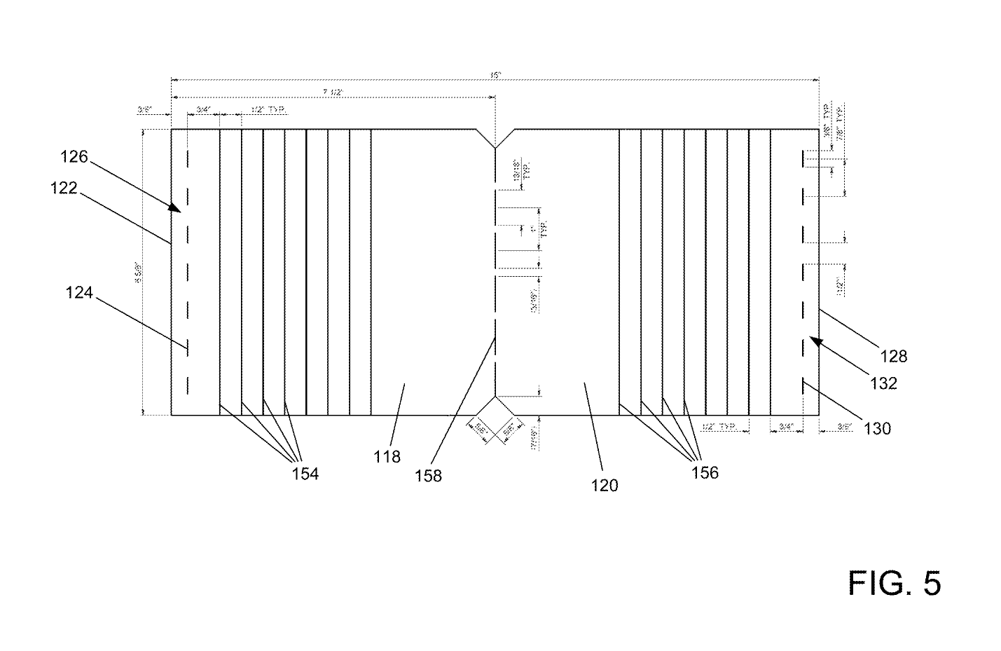

FIG. 5 illustrates the first and second side flaps 118, 120 by themselves, including various dimensions of the first and second side flaps 118, 120. As a first example, FIG. 5 illustrates that the first and second side flaps 118, 120 can each have an overall length of 7½ inches, and an overall width of 6⅝ inches. The primary score line 124 is located ⅜ of an inch from the first edge 122 of the first side flap 118, so that the first end portion 126 is ⅜ of an inch wide. Similarly, the primary score line 130 is located ⅜ of an inch from the first edge 128 of the second side flap 120, so that the first end portion 132 is ⅜ of an inch wide.

The first side flap 118 includes a third plurality of fold lines 154 and the second side flap 120 includes a fourth plurality of fold lines 156, each of which extend across a width of the respective side flap 118 or 120 parallel to the respective first edges 122 or 128, and therefore also parallel to the direction of the corrugations or flutes of the corrugated cardboard of the first and second side flaps 118 and 120. Each of the primary fold lines 124, 130, and pluralities of fold lines 154, 156 can comprise a scoreline cut into one or both major surfaces of the respective side flap 118 or 120. Each of the primary fold lines 124, 130, and the pluralities of fold lines 154, 156 can also, or in the alternative, comprise a pre-crushed fold line and/or a machine-crushed fold line. Each of the primary fold lines 124, 130, and the pluralities of fold lines 154, 156 can also, or in the alternative, comprise a perforated cut through the full thickness of the respective side flap 118 or 120. As illustrated in FIG. 5, one suitable configuration for such perforated cuts can include cuts that are ⅜ of an inch long and spaced apart from one another by ½ of an inch end to end, or ⅞ of an inch center to center, although in alternative implementations, the perforated cuts can be replaced by a continuous cut or can be omitted. The primary fold lines 124, 130, and the pluralities of fold lines 154, 156, can make it simpler and more efficient for a human or a machine to fold up the packaging system 100 to package a good therein.

The third plurality of fold lines 154 can include eight distinct fold lines 154 that extend parallel to one another along the width of the first side flap 118, and one of the fold lines 154 which is located the furthest of the fold lines 154 from the first edge 122 of the first side flap 118, is located 4⅝ inches from the first edge 122 of the first side flap 118. The rest of the third plurality of fold lines 154 can be spaced ½ inch apart from one another, such that the one of the fold lines 154 located closest to the first edge 122 is spaced apart from the primary fold line 124 by ¾ of an inch, and from the first edge 122 by 1⅛ inches.

Similarly, the fourth plurality of fold lines 156 can include eight distinct fold lines 156 that extend parallel to one another along the width of the first side flap 120, and one of the fold lines 156 which is located the furthest of the fold lines 156 from the first edge 128 of the second side flap 120, is located 4⅝ inches from the first edge 218 of the second side flap 120. The rest of the second plurality of fold lines 156 can be spaced ½ inch apart from one another, such that the one of the fold lines 156 located closest to the first edge 128 is spaced apart from the primary fold line 130 by ¾ of an inch, and from the first edge 128 by 1⅛ inches.

The first and second side flaps 118 and 120 can be stamped or die cut to have the configuration, dimensions, and features described herein. As also illustrated in FIG. 5, the first and second side flaps 118 and 120 can be stamped or die cut as a unit, and distinctly from the main body 102. Stamping the first and second side flaps 118, 120 separately from the main body 102 and then adhering or gluing the first and second side flaps 118, 120 to the main body 102 can be particularly advantageous. In particular, stamping these components separately from one another can reduce overall waste material to below 20%, below 10%, below 5%, or about 0% of the corrugated cardboard stock or other material from which the side flaps 118, 120, and main body 102 are formed.

Further, forming these components separately from one another allows them to be formed from different materials, such as corrugated or un-corrugated cardboard, paperboard, or plastic films, or different grades of the same material, such as different grades of corrugated cardboard. For example, the side flaps 118 and 120 can be formed from a first grade of corrugated cardboard and the main body 102 can be formed from a second grade of corrugated cardboard that is different than the first. In some embodiments, the main body 102 and the first and second side flaps 118, 120 are formed of corrugated cardboard having E-flutes and a strength of 29 ECT as tested in accordance with standardized edge crush test (ECT) procedures. In some embodiments, the main body 102 and the first and second side flaps 118, 120 are formed of corrugated cardboard having B-flutes and a strength of 29 ECT as tested in accordance with standardized edge crush test (ECT) procedures. In some embodiments, the main body 102 is formed of corrugated cardboard having B-flutes and the first and second side flaps 118, 120 are formed of corrugated cardboard having E-flutes. In some embodiments, the main body 102 is formed of corrugated cardboard having E-flutes and the first and second side flaps 118, 120 are formed of corrugated cardboard having B-flutes. In various implementations, any of the main body 102 and the side flaps 118 and 120 can be formed from corrugated cardboard having A, B, C, D, or E-flutes, and having facing papers of any desired grade, such that they can have any desired ECT rating.

In a stamping or die cutting operation, the first and second side flaps 118 and 120 can be formed as a unit so that a second edge of the first side flap 118 opposite to the first edge 122 of the first side flap 118 is directly coupled to a second edge of the second side flap 120 opposite the first edge 128 of the second side flap 120 at a perforated cut line 158. The perforated cut line 158 divides the unit at its center into the first and second side flaps 118, 120. As illustrated in FIG. 5, one suitable configuration for the perforated cut 158 can include cuts that are 13/16 of an inch long and spaced apart from one another by 3/16 of an inch end to end, or 1.0 inch center to center. A person or a machine can tear the first side flap 118 from the second side flap 120 along the perforated cut line 158 as part of a process of assembling the packaging system 100.

FIG. 5 also illustrates that the corners of the side flaps 118 and 120 can be angled with respect to, not aligned with, or be oblique to, the respective second edges of the side flaps 118 and 120. In particular, the corners of the side flaps 118 and 120 along the respective second edges can be cut or trimmed (e.g., by the stamping or die-cutting operation) to form a trimmed corner edge having a length of ⅝ of an inch that extends 7/16 of an inch into the respective side flap 118 or 120 from a respective side thereof and along the second edge thereof.

A method of manufacturing the packaging system 100 can include stamping or die cutting the main body 102, and stamping or die cutting a unit including the first and second side flaps 118 and 120, and then separating the first and second side flaps 118 and 120 from one another. The method can also include applying the first, second, and third layers of adhesive 134, 136, 138 to the main body 102, and then using the first, second, and third layers of adhesive 134, 136, 138 to secure the first and second side flaps 118, 120 and the release liner 140 to the main body 102. The method can also include securing the tear strip 142 to the main body 102.

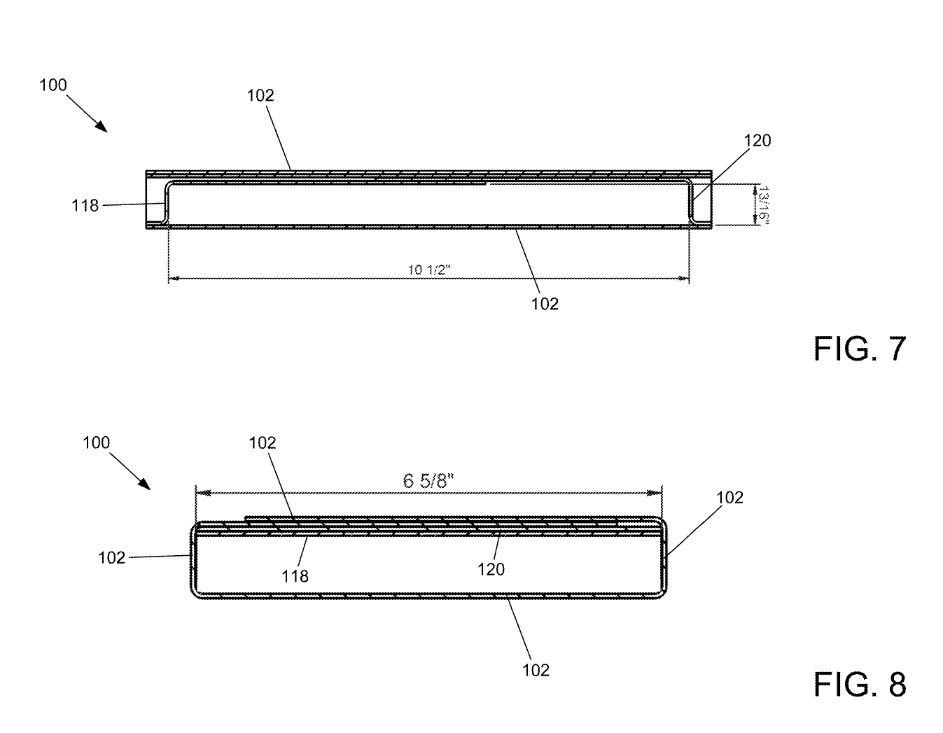

As described above, the packaging system 100 can be a variable depth packaging system 100, and the packaging system 100 can be used to package goods or items of various different sizes and various different depths. As a first example, FIG. 6 illustrates the packaging system 100 in a relatively small, or a minimal depth packaging arrangement wherein the packaging system 100 forms and completely encloses a relatively small internal void. FIGS. 7 and 8 illustrates cross-sectional views of the packaging system 100 in the minimal depth packaging arrangement shown in FIG. 6, taken along lines B-B and C-C shown in FIG. 6, respectively. As illustrated in FIGS. 7 and 8, the relatively small internal void can have dimensions of 10½ inches by 6⅝ inches by 13/16 inches and a good having a length up to 10½ inches, a width up to 6⅝ inches, and a depth up to 13/16 inches can be packaged snugly in the packaging system 100 in the minimal depth packaging arrangement without the use of any other packaging components.

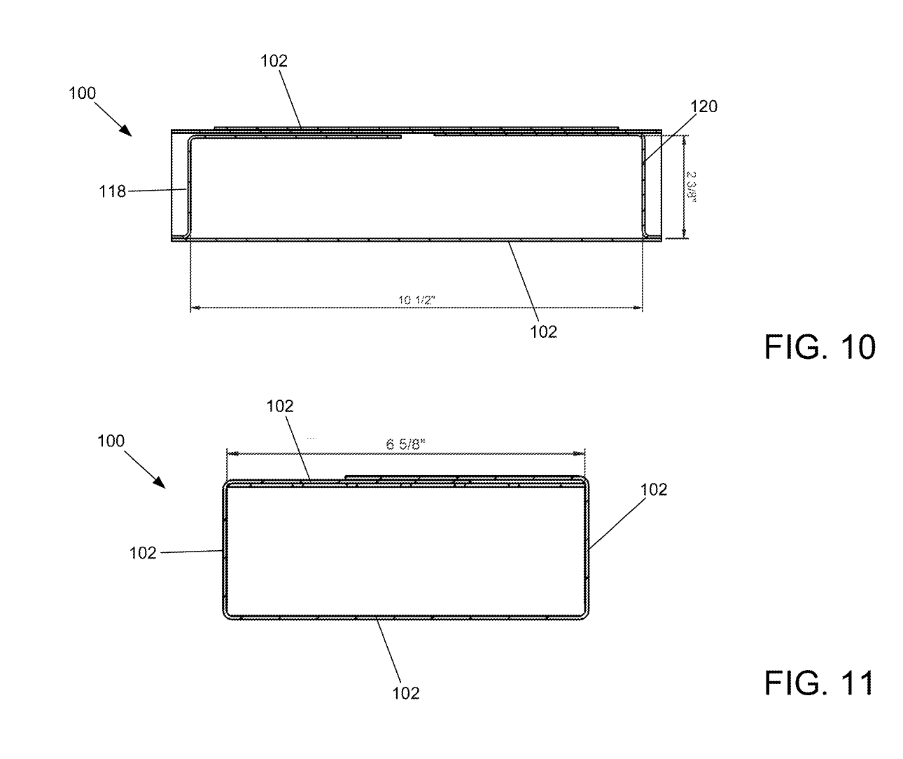

As a second example, FIG. 9 illustrates the packaging system 100 in a relatively large, or a maximal depth packaging arrangement wherein the packaging system 100 forms and completely encloses a relatively large internal void. FIGS. 10 and 11 illustrates cross-sectional views of the packaging system 100 in the maximal depth packaging arrangement shown in FIG. 9, taken along lines D-D and E-E shown in FIG. 9, respectively. As illustrated in FIGS. 10 and 11, the relatively large internal void can have dimensions of 10½ inches by 6⅝ inches by 2⅜ inches and a good having a length up to 10½ inches, a width up to 6⅝ inches, and a depth up to 2⅜ inches can be packaged snugly in the packaging system 100 in the maximal depth packaging arrangement without the use of any other packaging components.

To package a good within the packaging system 100, a person or a machine can receive the packaging system 100 in the configuration illustrated in FIG. 1, in which the first and second side flaps 118, 120 lie flat against the first major surface of the main body 102. The person or the machine can manipulate the packaging system 100 and fold the first and second side flaps 118, 120 along the respective primary fold lines 124, 130, so that the side flaps 118, 120 stand up and extend away from the main body 102. Such a fold is made with, or along, or parallel to, the flutes or corrugations of the side flaps 118, 120. The user or the machine can then position a good to be packaged on top of the first major surface 112 of the main body 102 between the first and second side flaps 118, 120.

The person or the machine can then select specific fold lines from the third and fourth pluralities of fold lines 154, 156, based on the depth of the good being packaged, and fold the first and second side flaps 118, 120 along the selected fold lines to extend over the top of the good being packaged. In many cases, simply pushing or folding the side flaps 118, 120 over the top of the good being packaged can result in specific fold lines from the third and fourth pluralities of fold lines being automatically selected. These folds are made with, or along, or parallel to, the flutes or corrugations of the side flaps 118, 120. For relatively narrow goods, the selected fold lines can be relatively close to the respective primary fold lines 124 and 130. For relatively thick goods, the selected fold lines can be relatively far from the respective primary fold lines 124 and 130.

The person or the machine can then select a specific fold line from the first plurality of fold lines 114, based on a width of the good being packaged, and fold the main body 102 along the selected fold line 114 so that its first end 104 is raised upward and away from the rest of the main body 102. Such a fold is made with, or along, or parallel to, the flutes or corrugations of the main body 102. The person or the machine can then select another specific fold line from the first plurality of fold lines 114, based on a depth of the good being packaged, and fold the main body 102 along the selected fold line 114 to extend over the top of the good being packaged and over the first and second side flaps 118, 120 as they extend over the top of the good being packaged as well. Such a fold is made with, or along, or parallel to, the flutes or corrugations of the main body 102. Again, in many cases, simply pushing or folding the main body 102 over the top of the good being packaged can result in specific fold lines from the first plurality of fold lines being automatically selected. The person or the machine can then remove the release liner 140 from the main body 102 to expose the adhesive layer 138. The person or the machine can then select a specific fold line from the second plurality of fold lines 116, based on a width of the good being packaged, and fold the main body 102 along the selected fold line 116 so that its second end 106 is raised upward and away from the rest of the main body 102. Such a fold is made with, or along, or parallel to, the flutes or corrugations of the main body 102. The person or the machine can then select another specific fold line from the second plurality of fold lines 116, based on a depth of the good being packaged, and fold the main body 102 along the selected fold line 116 to extend over the top of the good being packaged, over the first end 104 of the main body 102, and over the first and second side flaps 118, 120, as they extend over the top of the good being packaged as well. Such a fold is made with, or along, or parallel to, the flutes or corrugations of the main body 102. Again, in many cases, simply pushing or folding the main body 102 over the top of the good being packaged can result in specific fold lines from the second plurality of fold lines being automatically selected.

In this way, a good can be packaged within the packaging system 100 by folding corrugated cardboard components only along fold lines parallel to the corrugations of the respective corrugated cardboard components. This can make the folding more precise and more efficient. A second portion of the main body 102 adjacent to the second end 106 of the main body 102 can then be pressed into a first portion of the main body 102 adjacent to the first end 104 of the main body 102 so that the exposed adhesive layer 138 engages the first portion of the main body 102 and seals and secures the first major surface 112 at the second portion of the main body 102 to the second major surface 160 at the first portion of the main body 102.

The good being packaged within the packaging system 100, the good and the packaging system 100 can then be shipped to a customer or other person or entity. A person or entity receiving the packaged good can open the packaging system 100 by pulling the tab 152 upward and away from the rest of the packaged good. Pulling the tab 152 initiates a tear across the width of the main body 102. Continuing to pull the tab 152 away from the rest of the package engages the reinforcing tear strip 142, and continues the tear across the width of the package until the tear extends all the way across the width of the main body 102, thereby separating the first end 106 of the main body 102 and the adhesive layer 138 from the rest of the main body 102 adjacent thereto. The package can then be opened by unfolding the packaging system 100 along the various fold lines.

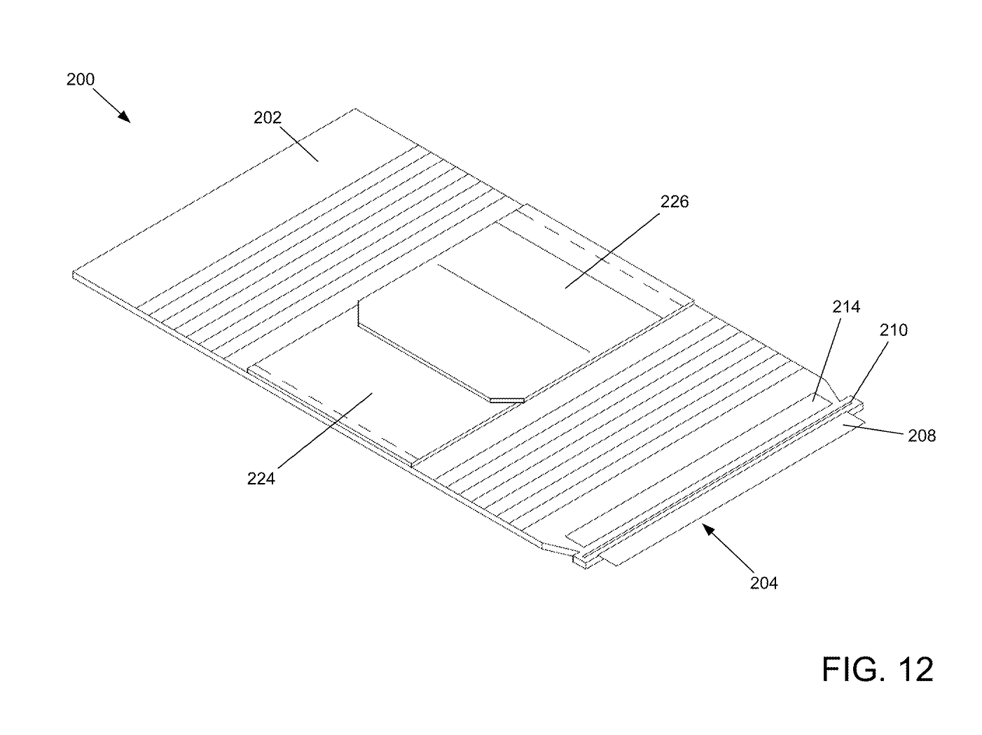

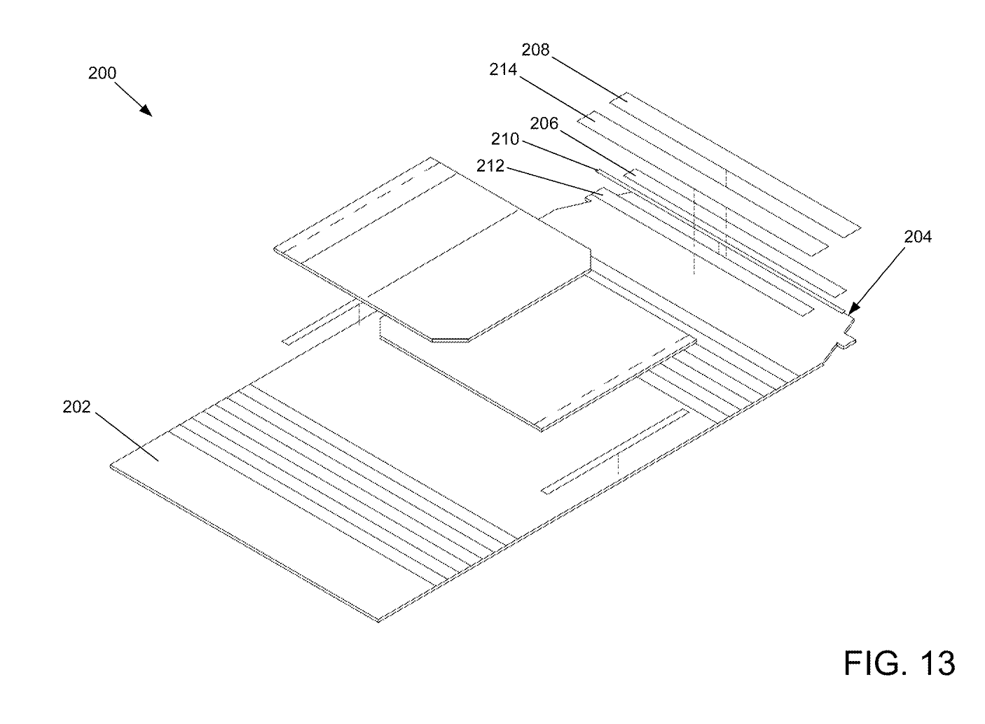

FIG. 12 illustrates a packaging system 200. Packaging system 200 includes various features similar or identical to those described herein for packaging system 100 and for the purposes of clarity, the following description of packaging system 200 focuses on the features of the packaging system 200 that are not described herein for packaging system 100. FIG. 13 illustrates an exploded view of the packaging system 200 that shows how the various components of the packaging system 200 are coupled to one another. For example, FIG. 12 illustrates that the packaging system 200 includes a main body 202 similar to the main body 102, which has a second end 204 similar to the second end 106 of the main body 102, a first side flap 224 similar to the first side flap 118, and a second side flap 226 similar to the second side flap 120.

The packaging system 200 also includes a first layer or strip of adhesive (e.g., a pressure sensitive adhesive or any hot melt adhesive, or a hot or cold glue, with a pressure sensitive adhesive, a hot glue, or any hot melt adhesive being particularly advantageous) 206 and a second layer or strip of adhesive (e.g., a pressure sensitive adhesive or any hot melt adhesive, or a hot or cold glue, with a pressure sensitive adhesive, a hot glue, or any hot melt adhesive being particularly advantageous) 212. The first layer of adhesive 206 can be positioned on the main body 202 adjacent to, parallel to, and along at least a portion of the second end 204 of the main body 202, and a first release liner 208 can be positioned on top of the first layer of adhesive 206 so that it is adhered to the main body 202. The packaging system 200 also includes a tear strip 210, which can be positioned on the main body 202 adjacent to and parallel to the first release liner 208, and coupled, adhered, or glued to the main body 202, such as by an adhesive built into or included within the tear strip 210. The second layer of adhesive 212 can be positioned on the main body 202 adjacent to and parallel to the tear strip 210, and a second release liner 214 can be positioned on top of the second layer of adhesive 212 so that it is adhered to the main body 202. Thus, the tear strip 210 can be positioned between the first and second adhesive layers 206, 212, and between the first and second release liners 208, 214.

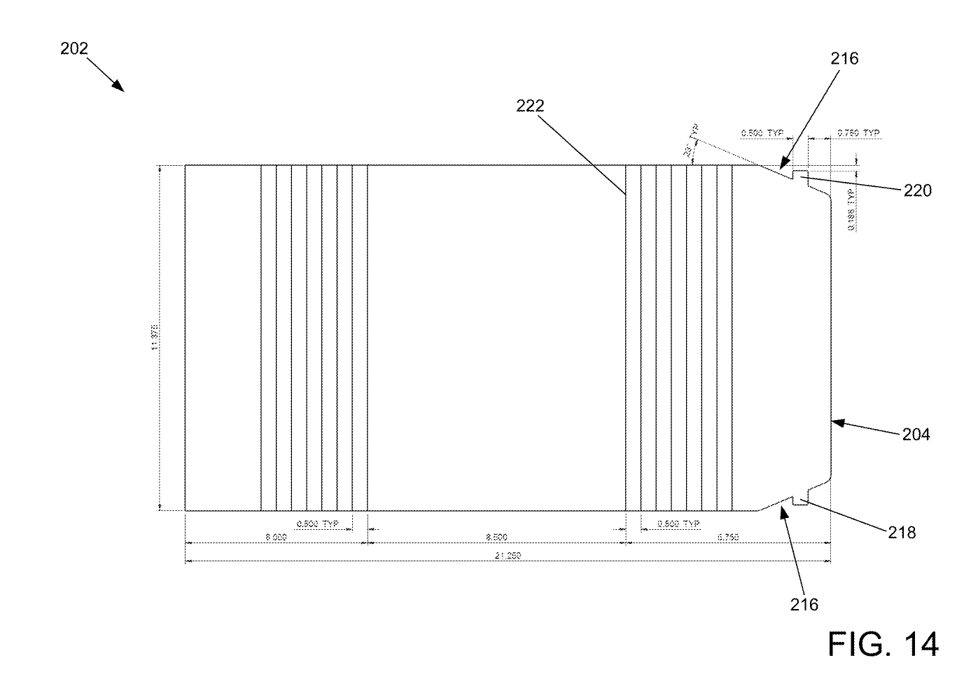

FIG. 14 illustrates that a width of the main body 202 parallel to the second end 204 of the main body 202 tapers at a taper portion 216 from its overall width to a relatively smaller width at the second end 204 of the main body 202. FIG. 14 illustrates that the taper portion 216 tapers inward from both sides of the main body 202 as the taper portion 216 extends toward the second end 204 of the main body 202, at 23° angles measured from the respective sides of the main body 202.

The taper portion 216 includes a first protrusion 218 that extends outward from the taper portion 216 in a direction parallel to the second end 204 of the main body 202, and a second protrusion 220 that extends outward from the taper portion 216 in a direction parallel to the second end 204 of the main body and opposite to that of the first protrusion 218. FIG. 14 illustrates that the first and second protrusions 218, 220 are each ½ of an inch wide and spaced apart from the second end 204 of the main body by ¾ of an inch. The first and second protrusions 218, 220 each extend outward from the taper portion 216 so that their respective terminal ends are offset inwards from, and extend shy of, the respective first and second sides of the main body 202 by 3/16 of an inch. As shown in FIG. 12, the tear strip 210 extends from a first end of the tear strip 210 positioned on the first protrusion 218 to a second end of the tear strip 210 positioned on the second protrusion 220.

The second end 204 of the main body extends ¾ of an inch farther than the second end 106 of the main body 102 does, so that the main body 202 has an overall length of 21¼ inches, and so that a furthest-inboard fold line 222 of a plurality of fold lines closest to the second end 204 of the main body 202 is located 6¾ inches away from the second end 204 of the main body 202.

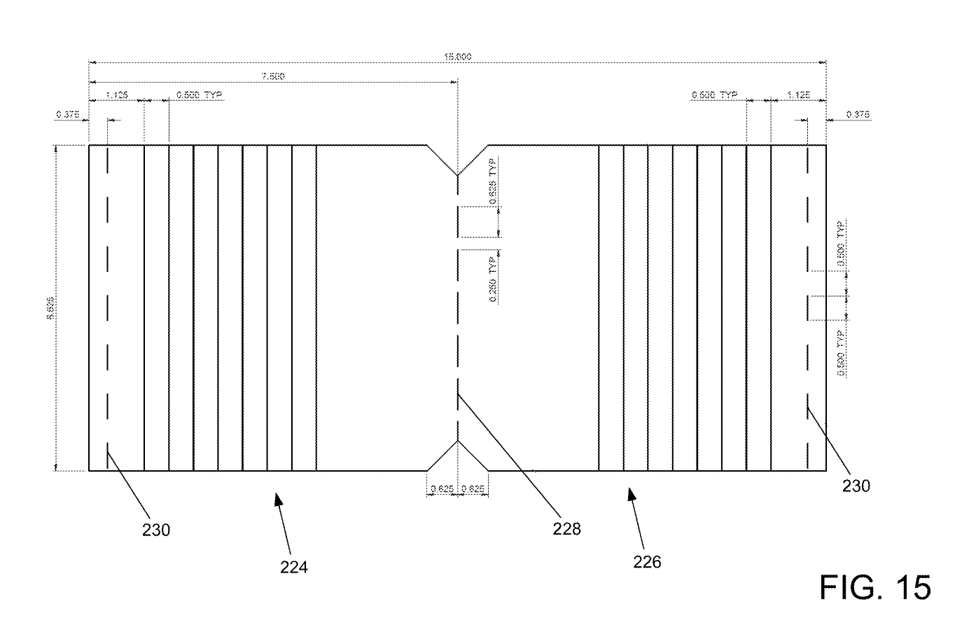

FIG. 15 illustrates the first and second side flaps 224, 226 by themselves. The first and second side flaps 224, 226 can be formed as a unit so that an edge of the first side flap 224 is directly coupled to an edge of the second side flap 226 at a perforated cut line 228. The perforated cut line 228 divides the unit at its center into the first and second side flaps 224, 226, and is perpendicular to first and second sides of both of the side flaps 224, 226. As illustrated in FIG. 15, one suitable configuration for the perforated cut 228 can include individual cuts that are ⅝ of an inch long and spaced apart from one another by ¼ of an inch end to end.

FIG. 15 also illustrates that the corners of the side flaps 224 and 226 along the edges of the side flaps 224 and 226 that are coupled to one another are angled with respect to, not aligned with, and oblique to, the respective edges of the side flaps 224 and 226 that are coupled to one another. In particular, the corners of the side flaps 224 and 226 along the respective edges can be cut or trimmed (e.g., by a stamping or die-cutting operation) to form a trimmed corner edge that extends ⅝ of an inch into the respective side flap 224 or 226 from the respective edge thereof and along the respective first or second side thereof.

FIG. 15 also illustrates that each of the first and second side flaps 224, 226 includes a respective primary fold line 230. Each of the primary fold lines 230 can comprise a perforated cut through the full thickness of the respective side flap 224 or 226. As illustrated in FIG. 15, one suitable configuration for such perforated cuts can include cuts that are ½ of an inch long and spaced apart from one another by ½ of an inch end to end.

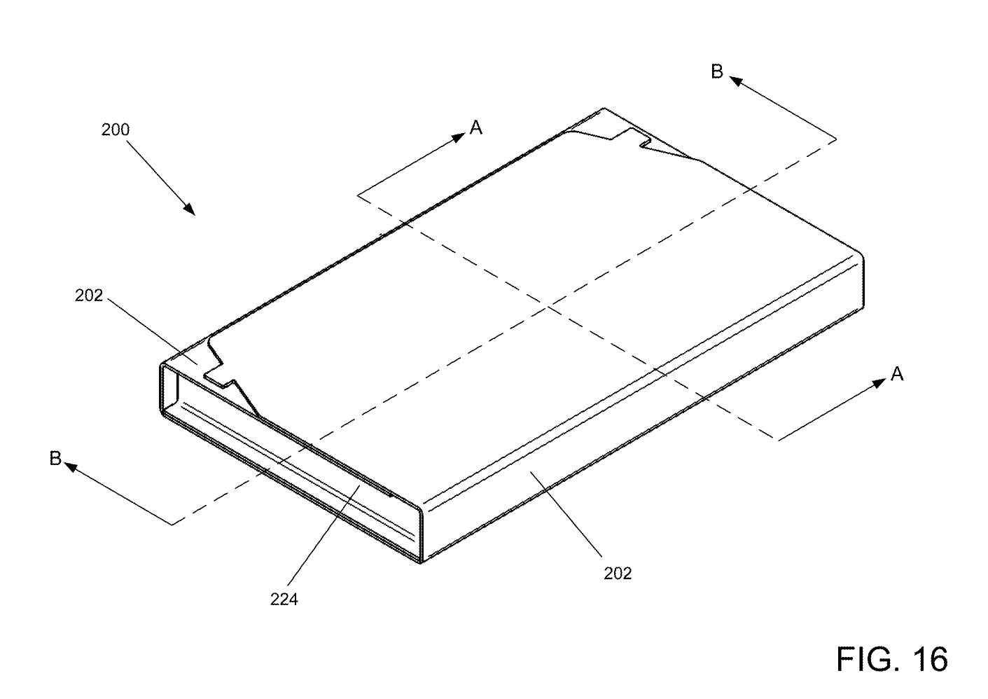

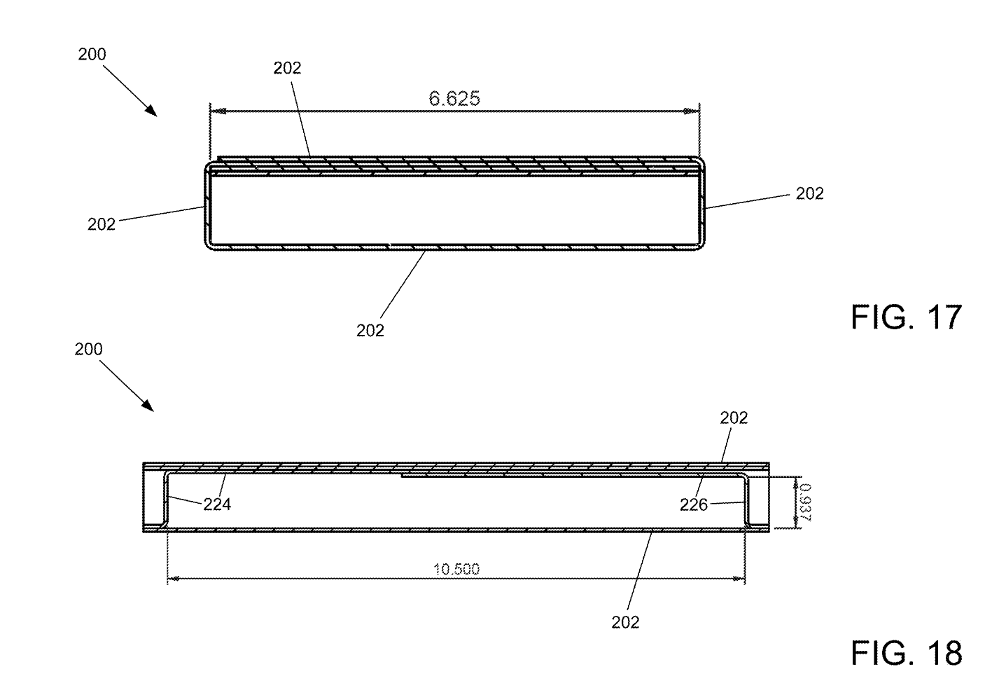

FIG. 16 illustrates the packaging system 200 in a relatively small, or a minimal depth packaging arrangement wherein the packaging system 200 forms and completely encloses a relatively small internal void. FIGS. 17 and 18 illustrates cross-sectional views of the packaging system 200 in the minimal depth packaging arrangement shown in FIG. 16, taken along lines A-A and B-B shown in FIG. 16, respectively. As illustrated in FIGS. 17 and 18, the relatively small internal void can have dimensions of 10½ inches by 6⅝ inches by 15/16 inches and a good having a length up to 10½ inches, a width up to 6⅝ inches, and a depth up to 15/16 inches can be packaged snugly in the packaging system 100 in the minimal depth packaging arrangement without the use of any other packaging components.

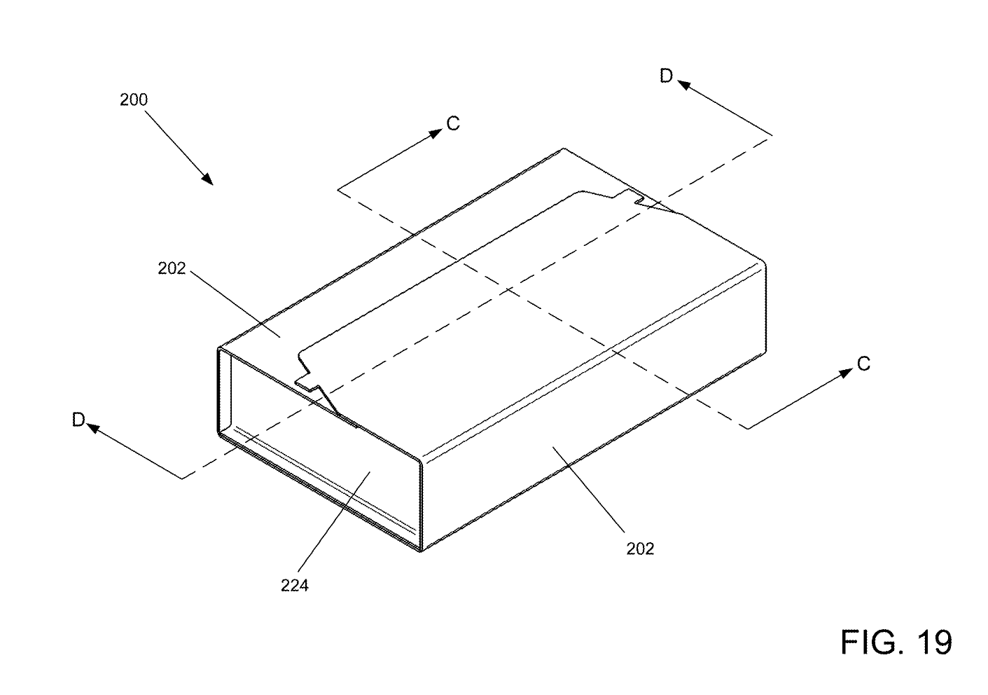

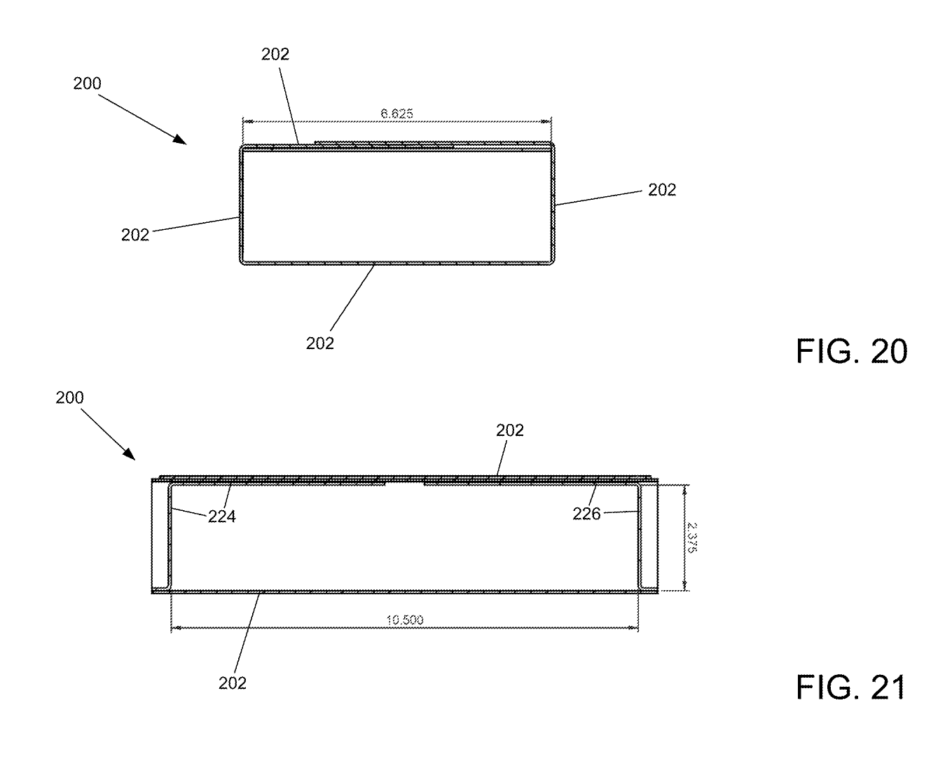

FIG. 19 illustrates the packaging system 200 in a relatively large, or a maximal depth packaging arrangement wherein the packaging system 200 forms and completely encloses a relatively large internal void. FIGS. 20 and 21 illustrates cross-sectional views of the packaging system 200 in the maximal depth packaging arrangement shown in FIG. 19, taken along lines C-C and D-D shown in FIG. 19, respectively. As illustrated in FIGS. 20 and 21, the relatively large internal void can have dimensions of 10½ inches by 6⅝ inches by 2⅜ inches and a good having a length up to 10½ inches, a width up to 6⅝ inches, and a depth up to 2⅜ inches can be packaged snugly in the packaging system 200 in the maximal depth packaging arrangement without the use of any other packaging components.

The packaging system 200 can be manipulated by a person or by a machine, and can be used and folded up to package a good, as described above for packaging system 100, such as to package a good for a vendor for shipping to a consumer. In doing so, the person or the machine can remove the first release liner 208 to expose the first layer of adhesive 206, which can be used to seal the packaging system 200 closed. The consumer receiving the packaged good can open the packaging system 200 by pulling the protrusion 218 and/or the protrusion 220 upward and away from the rest of the packaged good. Pulling on the protrusions 218, 220 initiates a tear across the width of the main body 202. Continuing to pull the protrusions 218, 220 away from the rest of the package engages the reinforcing tear strip 210, and continues the tear across the width of the package until the tear extends all the way across the width of the main body 202, thereby separating the second end 204 of the main body 202 and the first adhesive layer 206 from the rest of the main body 202 adjacent thereto.

The consumer receiving the good can then re-use the packaging system 200 to package a good, such as to re-package the good that was shipped by the vendor to the consumer, to return the good to the vendor. For example, if the consumer is dissatisfied with the good, the consumer can re-package the good in the packaging system 200 for return shipping to the vendor. To re-use the packaging system 200, a person or machine can manipulate and fold up the packaging system 200 around the good to be packaged and shipped as described above for packaging system 100. In doing so, the person or the machine can remove the second release liner 214 to expose the second layer of adhesive 212, which can be used to seal the packaging system 200 closed.

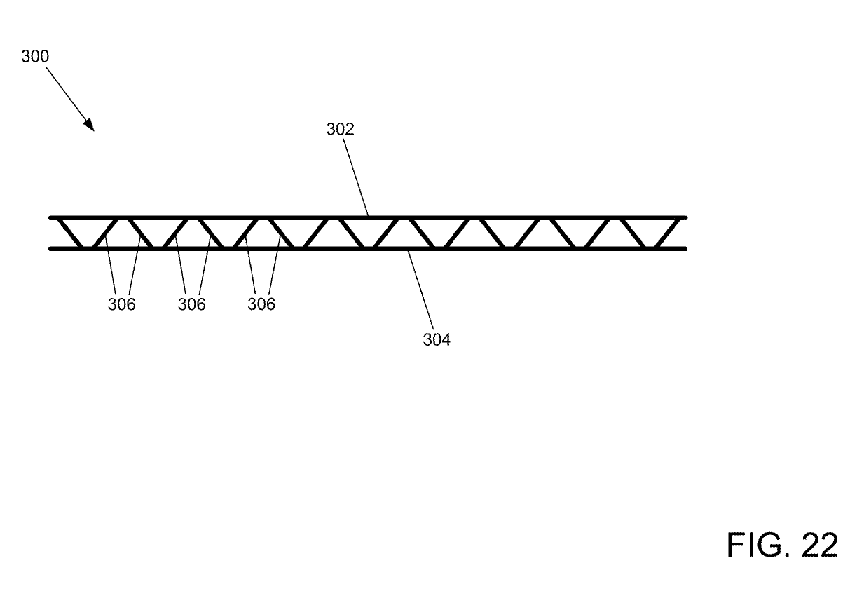

FIG. 22 illustrates one embodiment of a sheet of corrugated cardboard 300. FIG. 22 illustrates that the sheet of corrugated cardboard 300 includes a first sheet of facing paper 302, a second sheet of facing paper 304 that is spaced apart from and parallel to the first sheet of facing paper 302, and a plurality of flutes or corrugations that are coupled to and extend between the first and second sheets of facing paper 302 and 304.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A packaging system, comprising:
a main body including a first sheet of corrugated cardboard having first corrugations oriented in a first corrugation direction, the main body having a first end, a second end opposite the first end across a length of the main body, a first side, a second side opposite the first side across a width of the main body, a first major surface, and a second major surface opposite the first major surface across a thickness of the main body;
a first side flap including a second sheet of corrugated cardboard having second corrugations oriented in a second corrugation direction, the first side flap coupled to the first major surface of the main body adjacent to the first side of the main body, the first side flap configured to lie flat against the first major surface of the main body;
a second side flap including a third sheet of corrugated cardboard having third corrugations oriented in a third corrugation direction, the second side flap coupled to the first major surface of the main body adjacent to the second side of the main body, the second side flap configured to lie flat against the first major surface of the main body;
wherein when the first side flap lies flat against the first major surface of the main body, the first corrugation direction is perpendicular to the second corrugation direction; and
wherein when the second side flap lies flat against the first major surface of the main body, the first corrugation direction is perpendicular to the third corrugation direction.

2. The packaging system of claim 1 wherein the first side flap includes a first edge immediately adjacent to the first side of the main body and the second side flap includes a second edge immediately adjacent to the second side of the main body.

3. The packaging system of claim 2 wherein the first side flap has a first overall length, the second side flap has a second overall length, and a sum of the first and second overall lengths is greater than the width of the main body.

4. The packaging system of claim 1 wherein the first side flap includes a plurality of fold lines.

5. The packaging system of claim 1 wherein the main body includes a plurality of fold lines.

6. The packaging system of claim 1, further comprising a pressure sensitive adhesive positioned on the first major surface of the main body adjacent to the second end of the main body, and a release liner positioned on the pressure sensitive adhesive.

7. The packaging system of claim 6, further comprising a tear strip positioned on the first major surface of the main body adjacent to the pressure sensitive adhesive and to the release liner.

8. The packaging system of claim 7, further comprising a second pressure sensitive adhesive positioned on the first major surface of the main body adjacent to the tear strip, and a second release liner positioned on the second pressure sensitive adhesive.

9. The packaging system of claim 6 wherein the first side flap, the second side flap, the first end of the main body, and the second end of the main body are configured to be folded to form and completely enclose an internal void space.

10. The packaging system of claim 9 wherein the void space has a length of 10½ inches, a width of 6⅝ inches, and a thickness of 15/16 inches.

11. The packaging system of claim 9 wherein the void space has a length of 10½ inches, a width of 6⅝ inches, and a thickness of 2⅜ inches.

12. The packaging system of claim 1 wherein the first sheet of corrugated cardboard has a first grade, the second sheet of corrugated cardboard has a second grade that is different than the first grade, and the third sheet of corrugated cardboard has a third grade that is different than the first grade.

13. A method of manufacturing a packaging system comprising:
forming a main body of the packaging system from a first sheet of corrugated cardboard, the main body including first corrugations oriented in a first corrugation direction, a first end, a second end opposite the first end across a length of the main body, a first side, a second side opposite the first side across a width of the main body, a first major surface, and a second major surface opposite the first major surface across a thickness of the main body;
forming a first side flap of the packaging system and a second side flap of the packaging system from a second sheet of corrugated cardboard, the first side flap including second corrugations oriented in a second corrugation direction, the second side flap including third corrugations oriented in a third corrugation direction;
coupling the first side flap to the first major surface of the main body adjacent to the first side of the main body so that the first side flap is configured to lie flat against the first major surface of the main body and when the first side flap lies flat against the first major surface of the main body, the first corrugation direction is perpendicular to the second corrugation direction; and
coupling the second side flap to the first major surface of the main body adjacent to the second side of the main body so that the second side flap is configured to lie flat against the first major surface of the main body and when the second side flap lies flat against the first major surface of the main body, the first corrugation direction is perpendicular to the third corrugation direction.

14. The method of claim 13 wherein forming a first side flap of the packaging system and a second side flap of the packaging system from a second sheet of corrugated cardboard includes stamping the first side flap and the second side flap as an integral unit and then separating the first side flap from the second side flap.

15. A method of using a packaging system comprising: a main body including a first sheet of corrugated cardboard having first corrugations oriented in a first corrugation direction, the main body having a first end, a second end opposite the first end across a length of the main body, a first side, a second side opposite the first side across a width of the main body, a first major surface, and a second major surface opposite the first major surface across a thickness of the main body; a first side flap including a second sheet of corrugated cardboard having second corrugations oriented in a second corrugation direction, the first side flap coupled to the first major surface of the main body adjacent to the first side of the main body, the first side flap configured to lie flat against the first major surface of the main body; a second side flap including a third sheet of corrugated cardboard having third corrugations oriented in a third corrugation direction, the second side flap coupled to the first major surface of the main body adjacent to the second side of the main body, the second side flap configured to lie flat against the first major surface of the main body; wherein when the first side flap lies flat against the first major surface of the main body, the first corrugation direction is perpendicular to the second corrugation direction; and wherein when the second side flap lies flat against the first major surface of the main body, the first corrugation direction is perpendicular to the third corrugation direction, the method comprising:
folding the first side flap along a first fold line parallel to the second corrugation direction so the first side flap extends away from the main body;
folding the second side flap along a second fold line parallel to the third corrugation direction so the second side flap extends away from the main body;
positioning an item to be packaged on the first major surface of the main body between the first and second side flaps;
folding the first side flap along a third fold line parallel to the second corrugation direction so the first side flap extends over the top of the item;
folding the second side flap along a fourth fold line parallel to the third corrugation direction so the second side flap extends over the top of the item;
folding the main body along a fifth fold line parallel to the first corrugation direction so the first end of the main body is raised upward from the rest of the main body;
folding the main body along a sixth fold line parallel to the first corrugation direction so the first end of the main body extends over the top of the item;
folding the main body along a seventh fold line parallel to the first corrugation direction so the second end of the main body is raised upward from the rest of the main body; and
folding the main body along an eighth fold line parallel to the first corrugation direction so the second end of the main body extends over the top of the item.

16. The method of claim 15, further comprising:
removing a release liner from a pressure sensitive adhesive positioned on the first major surface of the main body adjacent to the second end of the main body; and
pressing the pressure sensitive adhesive into the second major surface of the main body to secure the first major surface of the main body to the second major surface of the main body.
